(19) United States
(12) Patent Application Publication
(10) Pub. No.: US 2015/0080203 A1
(43) Pub. Date: Mar. 19, 2015

(54) METHOD FOR SEPARATING A DISPERSION

(71) Applicant: Bohdan Anatoliovych Martyniuk, Khmelnitsky (UA)

(72) Inventor: Bohdan Anatoliovych Martyniuk, Khmelnitsky (UA)

(21) Appl. No.: 14/390,107

(22) PCT Filed: May 24, 2012
(86) PCT No.: PCT/UA2012/000053

§ 371 Date: Oct. 2, 2014

(30) Foreign Application Priority Data
Apr. 2, 2012 (UA) 2012-03948

(51) Int. Cl. B01D 17/02

(52) U.S. Cl. CPC B01D 17/0217
USPC 494/37

(57) ABSTRACT

The method for separating a dispersion system into constituents, for example, for separating an oil emulsion into oil and water. This invention is based on the problem of, in a known method of dehydrating dispersions by specifying and regulating the output resistance of the liquid constituent of a mixture with a large specific weight, ensuring the following technical result: high-quality separation of the dispersion in accordance with the specific weight into constituents in apparatuses of simplified design. The method for separating a dispersion comprises supplying the liquid mixture for centrifuging, separating and regulating the extraction of the constituents, the extraction of the constituents is regulated by specifying the output resistance of the liquid constituent of the mixture with a large specific weight, and regulation of the extraction is controlled by a specified quantity of the liquid constituent of the mixture with a large specific weight in the centrifuge.

The invention can be used in process systems which are employed for separating of dispersion systems under the influence of centrifugal force, for instance in order to separate a petroleum emulsion into the constituents of crude oil and water.

From the invention in Russian Patent RU 1438818 (USSR, 1988), a system for separating petroleum, gas and water is known. This system employs a centrifugal-force-based separating method. The disadvantages of this system are its complicated construction and unreliable operation.

The closest prior art to the technical solution of the present application is a method for dehydrating suspensions. This method is implemented in the invention entitled “Vertical Centrifuge for Suspension Dehydrating” (Intellectual Property Document Product RU 129566, Information Sheet No. 13, 1960). It includes delivery of a liquid mixture for centrifuging and separating and regulating the extraction of the constituents. However, this method has some disadvantages, since the compressed product is extracted via radial holes. The radial holes are embodied in a movable centrifuge housing. The extraction is regulated by changing the cross section of the radial holes. The radial holes are embodied in the immovable centrifuge housing; therefore the constructions of the systems for performing this method are complicated and do not ensure satisfactory quality of the process.

In this method, as in most other centrifuges and precipitators, the control of the regulation process is done with a control unit data obtained from various transducers. These transducers detect the composition of the separable substances. Such control is done once the transducers have reported that a quantity of a different substance has penetrated into the extracted, separated substance. After that, the control unit sends a command to the device for regulating the extraction. As a result, the output of the constituents is changed. Alternatively, there is no control whatsoever of the course of regulation (during operation). Only the appropriate setting is calibrated before starting operation. In this kind of centrifuging it is not possible to achieve a stable quality of the separated substances.

It is the object of the invention, in the known method for dehydrating dispersion systems by means of setting and regulating output resistance of a liquid mixture constituent with a high specific weight, to achieve the technical effect according to the invention. The technical effect is high-quality separating of a dispersion system in accordance with the specific weight of each of the constituents to be separated, and the separating system should have a simplified construction.

This stated object is attained by the features of claim 1.

The method for separating of a dispersion system includes a delivery of a liquid mixture and centrifuging, separation and regulating the extraction of the constituents. Regulating the extraction of the constituents is done by setting a output resistance of a liquid mixture constituent having a higher specific weight. Regulating the extraction is controlled by setting a defined quantity of the liquid mixture constituent having a higher specific weight in the centrifuge.

Advantageous refinements of the method can be learned from the dependent claims.

In one of the embodiments of the invention, output resistance of the liquid mixture constituent having the higher specific weight is achieved with the aid of a spring-loaded valve.

In a further embodiment of the invention, output resistance of the liquid mixture constituent having the higher specific weight is achieved in that a liquid column of the liquid mixture is set.

The aforementioned novel features (setting output resistance of the liquid mixture constituent having the higher specific weight and setting a defined level of the liquid mixture constituent having the higher specific weight in the centrifuge), including cooperation with the known features (delivery of a liquid mixture to centrifuging, separation (fractionation) and regulating the extraction of the constituents), have the result that novel properties of the invention are defined and that the technical effect of the invention is achieved, specifically: a high-quality separating of the dispersion system in accordance with the specific weight of the constituents of the mixture in the systems with a simplified construction. The method of the invention for separating of a dispersion system makes it possible to achieve the usage properties that are due to the technical effect. This results in savings while the constituents of the dispersion system are being conveyed and makes the method usable in overcoming the consequences of environmental catastrophes.

The invention will be described in further detail in terms of an exemplary embodiment shown in the accompanying drawings. In the drawings:

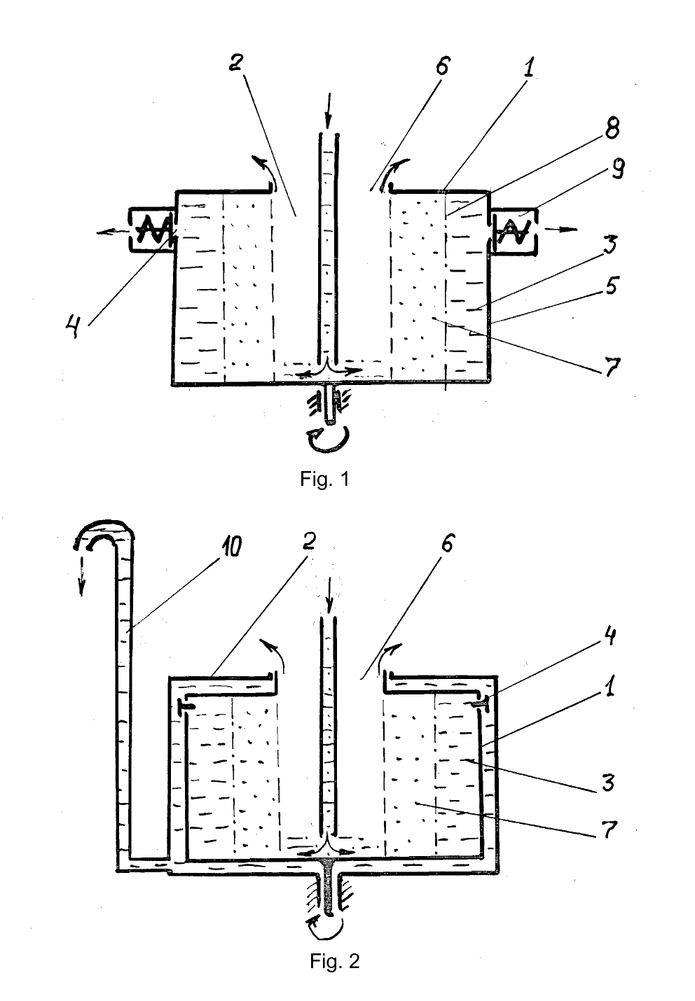

FIG. 1 is a process diagram for describing the performance of the method in an embodiment having a valve; and

FIG. 2 shows an embodiment of the method having a regulating liquid column.

The method for separating of a dispersion system is performed as follows.

In the embodiment with a spring-loaded valve: Before the separating is performed, the course of regulation is set, depending on the type of constituents of the dispersion system that are to be separated. In the embodiment with a regulating liquid column: The course of regulation can be set during operation of the centrifuge. The liquid constituent 3 having a higher specific weight is delivered to a drum 1 of a revolving centrifuge 2. The liquid constituent 3 having the higher specific weight is subjected via holes 4 in the drum 1 to such a pressure that the level of the liquid constituent 3 in the centrifuge drum 1 is located between an outer wall 5 of the centrifuge drum 1 and an outlet opening 6 for the liquid constituent 7 having a lesser specific weight. After that, given an unchanging rotary speed and an unchanging pressure, the level of the liquid constituent 3 will also be invariable, regardless of the quantity of liquid constituent delivered to the drum 1 of the centrifuge 2.

If the liquid constituent 7 having the lesser specific weight enters the drum 1 of the centrifuge 2 simultaneously with the liquid constituent 3 having the higher specific weight, then as a consequence of the effect of centrifugal force a boundary face 8 is created. The liquid constituent 7 passes beyond the boundaries of the centrifuge drum 1, leaving it through the outlet opening 6. The outlet opening 6 is located above the boundary face 8 and/or closer to the axis of rotation than the highest point of the liquid constituent.

Either the resistance of a spring-loaded valve 9 or the liquid column 10 of the liquid constituent 3 is set such that the liquid constituent 3 is extracted only through the hole 4. The liquid constituent 7 is delivered to the drum 1 of the centrifuge 2 without a liquid constituent 3 and cannot flow out through the hole 4. Therefore it is extracted to the outside only through the outlet opening 6.

Depending on the variation of the ratio of constituents in the dispersion system, the boundary face 8 can vary in the region between the level of the liquid constituent 3 (without the liquid constituent 7) and the ensured minimum level of the liquid constituent 3, if a concentrated dispersion system is supplied with a high proportion of the liquid constituent 7.

The resistance of the spring-loaded valve 9 or the height of the column 10 of the liquid constituent 3 regulates (controls) the level (quantity) of the liquid constituent 3 in the middle of the drum 1 of the centrifuge 2. The quantity (level) of the liquid constituent 3 inside of the drum 1 of the centrifuge 2 controls the flow-through capacity of the valve 9 or of the liquid column 10.

The novel separating method can be employed in order to separate arbitrary liquid mixtures, both emulsions and suspensions. The emulsions are split into a liquid having a higher specific weight and a liquid having a lower specific weight. The suspensions are split into a clarified liquid constituent and a condensed liquid constituent. Simultaneously with the separation of the liquid substances, their degassing takes place. In the case of centrifuging a petroleum/water system, extraction of solids in the petroleum by precipitation is also performed. In the process, the solid inclusions are extracted together with water.

What is claimed is:

1. A method for separating of a dispersion system, including delivering a liquid mixture for centrifuging, separating and regulating an extraction of constituents,
characterized in that
regulating the extraction of the constituents is performed by setting an output resistance of a liquid mixture constituent (3) having a higher specific weight; and
regulating the extraction is controlled by a determined quantity of the liquid mixture constituent (3) having a higher specific weight in a centrifuge (2).

2. The method of claim 1, wherein
the output resistance of the liquid mixture constituent (3) having the higher specific weight is achieved using a valve (9).

3. The method of claim 1, wherein
output resistance of the liquid mixture constituent (3) having the higher specific weight is achieved by setting a liquid column (10) of the higher specific weight liquid.
